(19) United States
(12) Patent Application Publication
(10) Pub. No.: US 2023/0083241 A1
(43) Pub. Date: Mar. 16, 2023

(54) Cycle Battery Lock

(71) Applicant: Yaakov Oren Ben Shabat, Bnei Brak (IL)

(72) Inventor: Yaakov Oren Ben Shabat, Bnei Brak (IL)

(21) Appl. No.: 17/942,146

(22) Filed: Sep. 11, 2022

Related U.S. Application Data
(60) Provisional application No. 63/244,010, filed on Sep. 14, 2021.

(51) Int. Cl. B62H 5/00; B62J 43/20

(52) U.S. Cl. CPC B62H 5/001; B62J 43/20; B62H 5/003

(57) ABSTRACT

A system and method for an electric bicycle battery anti-theft shield and/or cover that may be fitted to parts of an electric bicycle to hinder theft of the electric bicycle battery and/or components thereof. The system and method may also hinder theft of additional electric bicycle components and even hinder theft of the bicycle itself.

### RELATED APPLICATION/S

This application claims the benefit of priority under 35 USC § 119(e) of U.S. Provisional Patent Application No. 63/244,010 filed 14 Sep. 2021, the contents of which are incorporated herein by reference in their entirety.

### FIELD AND BACKGROUND OF THE INVENTION

The present invention, in some embodiments thereof, relates to an anti-theft shield and, more particularly, but not exclusively that may be fitted to parts of an electric bicycle.

With the increase in popularity of electric bicycles and scooters for both transportation and recreation, there is a growing market for low-cost batteries and battery components. Often, it is impractical to store electric bicycles indoors e.g., in offices, apartments, etc. Therefore, parking electric bicycles on the street is common. Removing a battery from an electric bicycle may also be inconvenient and unwieldy. Additionally, many services which provide electric bicycles for rent park their bicycles on the street for easy access by commuters. Unfortunately, this provides the opportunity for theft of the bicycle, bicycle batteries or components thereof.

Therefore, there is a need for an anti-theft device for electric bicycle batteries and components thereof.

### SUMMARY OF THE INVENTION

According to an aspect of some embodiments of the invention, there is provided a system preventing theft system of a battery of an electric bicycle including: a rail connecting the battery to the electric bicycle; a shield attached to an upper portion of the rail; and a lock, connecting to the shield and inhibiting removal of the battery from the electric bicycle.

According to an aspect of some embodiments of the invention, there is provided a system preventing theft system of a battery of an electric bicycle including: a rail connecting the battery to the electric bicycle; a shield attached to an upper portion of the rail; and a lock, connecting to the shield and inhibiting removal of the battery from the electric bicycle.

According to some embodiments of the invention, an attachment between the rail and the shield is covered by the battery when the lock in connected to the shield to inhibits removal of the battery thereby inhibiting separating the shield from the rail.

According to some embodiments of the invention, the shield is attached to the rail by means of at least one screw.

According to some embodiments of the invention, the shield includes a locking bolt hole.

According to some embodiments of the invention, the lock passes through the locking bolt hole of the shield.

According to some embodiments of the invention, the system further includes a cover at least partially covering the shield and inhibiting access to a location of attachment of the shield and the rail.

According to some embodiments of the invention, the lock inhibits removing the cover from the shield.

According to some embodiments of the invention, the system further includes a cover held to an upper portion of the battery by the lock.

According to some embodiments of the invention, the cover covers the upper portion of the battery, including a portion of a top and a portion of two opposing sides thereof.

According to some embodiments of the invention, the cover further covers at least part of a third side of the battery.

According to some embodiments of the invention, the cover surrounds the upper portion of the battery, including a portion of four sides thereof.

According to some embodiments of the invention, the cover sits below the lock.

According to some embodiments of the invention, the cover is attached to the shield.

According to some embodiments of the invention, the cover is attached to the rail.

According to some embodiments of the invention, the cover is attached to the shield or the rail by a hinge.

According to some embodiments of the invention, the cover is connected to an additional bicycle component.

According to some embodiments of the invention, the cover is connected to an additional bicycle component by at least one loop of a cable, a strap or a chain.

According to some embodiments of the invention, the lock prevents disconnection of the loop from at least one of the covers and the shield.

According to some embodiments of the invention, the cover is connected to an additional bicycle component by a lock.

According to some embodiments of the invention, the cover is connected to an external component.

According to some embodiments of the invention, the cover is connected to an external component by a cable, chain or lock.

According to some embodiments of the invention, the cover covers a key hole of a native bolt between the electric bicycle battery and the rail.

According to some embodiments of the invention, the lock and the shield are connected to an additional bicycle component.

According to some embodiments of the invention, the lock and the shield are connected to an additional bicycle component by a loop.

According to some embodiments of the invention, the additional bicycle component is a saddle, peddles, gear chain, handlebar, child seat, or luggage rack.

According to some embodiments of the invention, a connection between the shield and the additional bicycle component is tight enough to inhibit moving the shield away from the battery.

According to some embodiments of the invention, the lock and the shield are connected to an external component.

According to some embodiments of the invention, the lock and the shield are connected to an external component by a loop.

According to some embodiments of the invention, the external component is a sturdy object selected from a pole, flower pot, bicycle rack, lamp post, building or tree.

According to an aspect of some embodiments of the invention, there is provided a method of preventing theft of a battery of an electric bicycle including: connecting the battery to the electric bicycle battery by a rail affixing a shield to at least one of the battery and the rail; and locking a lock to the shield inhibiting removal of the battery from the rail.

According to some embodiments of the invention, the method further includes covering an upper portion of the battery with a cover, wherein the cover is positioned below the lock such that the lock inhibits removal of the cover from the battery.

According to some embodiments of the invention, the method further includes rotating the cover around a hinge to cover the upper portion of the battery.

According to some embodiments of the invention, the method further includes covering a connection between the rail and the shield with a cover, wherein the cover is positioned below the lock such that the lock inhibits removal of the cover from the battery.

According to some embodiments of the invention, the method further includes passing the lock through a hole in the shield.

According to some embodiments of the invention, the method further includes securing an additional bicycle component to the lock, shield, cover, or combination thereof.

According to some embodiments of the invention, the method further includes securing an external component to the lock, shield, cover, or combination thereof.

According to some embodiments of the invention, the method further includes wrapping a loop to secure an object.

According to some embodiments of the invention, the object includes at least one of a component of the bicycle and an object fixed in its location.

According to some embodiments of the invention, the method further includes: connecting an end of the loop to the shield, and inhibiting removal of the loop from the shield by means of the lock.

According to some embodiments of the invention, the method further includes: connecting an end of the loop to at least one component selected from the shield and a cover covering a portion of the battery, and inhibiting removal of the loop from the component by means of the lock.

According to some embodiments of the invention, the method further includes, inhibiting access to a means of the affixing by means of the locking.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practice.

In the drawings:

FIG. 1A: A schematic illustration of an exemplary battery after attachment to a battery rail in accordance with some embodiments of the invention.

FIG. 1B: A schematic illustration of an exemplary battery before attachment to a battery rail in accordance with some embodiments of the invention.

FIG. 2: A schematic illustration of an exemplary battery attached to a battery rail with a shield in accordance with some embodiments of the invention.

FIG. 3A: A schematic illustration of an exemplary battery attached to a battery rail with a shield and strap in accordance with some embodiments of the invention.

FIG. 3B: A schematic illustration of an exemplary battery attached to a battery rail with a shield and lock in accordance with some embodiments of the invention.

FIG. 4A: A schematic illustration of an exemplary battery attached to a battery rail with a cover in accordance with some embodiments of the invention.

FIG. 4B: A cut away view of a schematic illustration of an exemplary battery attached to a battery rail with a cover in accordance with some embodiments of the invention.

FIG. 5A: A schematic illustration of a battery attached to an exemplary battery rail with an open cover in accordance with some embodiments of the invention.

FIG. 5B: A schematic illustration of an exemplary battery attached to a battery rail with a closed cover in accordance with some embodiments of the invention.

FIG. 6A: An exemplary image of an anti-theft system in accordance with some embodiments of the invention.

FIG. 6B: An exemplary image of an anti-theft system in accordance with some embodiments of the invention.

FIG. 6C: An exemplary image of an anti-theft system in accordance with some embodiments of the invention.

FIG. 6D: An exemplary image of an anti-theft system in accordance with some embodiments of the invention.

FIG. 7A: A schematic diagram illustrating an exemplary method in accordance with some embodiments of the invention.

FIG. 7B: A schematic diagram illustrating an exemplary method in accordance with some embodiments of the invention.

FIG. 8: A schematic diagram illustrating an exemplary battery connected to a shield in accordance with some embodiments of the invention.

FIG. 9A: A front perspective view of a schematic diagram illustrating an exemplary cover in accordance with some embodiments of the invention.

FIG. 9B: A back perspective view of a schematic diagram illustrating an exemplary cover in accordance with some embodiments of the invention.

FIG. 9C: A back view of a schematic diagram illustrating an exemplary cover in accordance with some embodiments of the invention.

FIG. 9D: A top view of a schematic diagram illustrating an exemplary cover in accordance with some embodiments of the invention.

FIG. 10A: A schematic illustration of an exemplary anti-theft system in accordance with some embodiments of the invention.

FIG. 10B: A schematic illustration of an exemplary anti-theft system in accordance with some embodiments of the invention.

FIG. 11A: A schematic illustration of an exemplary anti-theft system in accordance with some embodiments of the invention.

FIG. 11B: A schematic illustration of an exemplary anti-theft system in accordance with some embodiments of the invention.

FIG. 12: A block diagram illustrating an exemplary anti-theft system in accordance with some embodiments of the invention.

FIG. 13: A block diagram illustrating an exemplary anti-theft system in accordance with some embodiments of the invention.

FIG. 14: A flow chart illustrating a method in accordance with some embodiments of the invention.

FIG. 15 is a perspective view of a cover with a hasp in accordance with an embodiment of the current invention.

FIG. 16A is a top orthogonal view of a shield with sideways extensions in accordance with an embodiment of the current invention.

FIG. 16B is a side orthogonal view of a shield with sideways extensions in accordance with an embodiment of the current invention.

FIG. 16C is a front orthogonal view of a shield with sideways extensions in accordance with an embodiment of the current invention.

### DETAILED DESCRIPTION

The present invention, in some embodiments thereof, relates to a shield and/or cover that may be designed to hinder theft of parts of an electric bicycle.

### Overview

An aspect of some embodiments of the current invention relates to a shield and/or cover that may be designed to hinder theft of parts of an electric bicycle, such as an electric bicycle battery and/or components thereof. Optionally, a battery of an electric bicycle may be locked in place with a lock and/or a locking bolt. Optionally, the lock and/or locking bolt may enter a hole of a shield, cover and/or rail, while thereby securing the battery and/or components thereof. Alternatively, and/or additionally, a battery may be fitted on a rail designed to fit into a groove in the battery. Optionally, the system may hinder a thief and/or tamperer from accessing the battery, the battery rail, locking bolt and/or components thereof. Alternatively, and/or additionally, there may be a need to additionally secure the battery in place while in motion. Alternatively, and/or additionally, the system may hinder theft of additional bicycle components, such as the saddle and/or theft of the bicycle itself. An embodiment of the current invention may be a shield and/or cover that may aid in hindering theft of bicycle batteries and/or parts thereof.

### Exemplary Embodiments

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

An aspect of some embodiments of the current invention relates to a shield and/or cover that may be designed to hinder theft of parts of an electric bicycle. According to some embodiments, the current invention relates to a system and/or method to hinder theft of parts of an electric bicycle.

In some embodiments, the cover and/or the shield may include a burglar alarm and/or a location indicating device. For example, the alarm may include a motion detector, a transmitter, a location indicating device, a camera and/or a warning element (e.g., a noise maker [e.g., a siren] and/or a visible signal [e.g., a light]). For example, when the bicycle is moved, the alarm may send a signal (e.g., a phone call and/or a text message) that the bicycle has been moved. Alternatively or additionally, a user may be able to remotely access the location indicating device to located the bicycle.

According to some embodiments, the anti-theft system may include a shield, which may be connected to a rail and/or bicycle battery and/or a cover. Optionally, the rail may fit within a groove on a bicycle battery. Optionally, the bicycle battery may be rechargeable. Optionally, the bicycle battery may be removable.

Advantageously, the shield may be attached to an existing rail and/or bicycle battery (e.g., bolted to the upper portion of a bicycle battery), thereby providing a simple and easy one size fits all solution without the need to produce a special custom extended rail for each type of battery.

According to some embodiments, the shield may be connected to the rail. Optionally, the shield may be an extension of the rail. Optionally, the shield may connect to the bicycle battery. Optionally, the shield may connect to a cover. Optionally, the cover may completely and/or partially cover the upper portion and/or sides of the bicycle battery. Optionally, the cover may be locked in place. Optionally, the cover may be connected to one or more additional bicycle components, e.g., saddle, etc. Optionally, this may hinder theft of an additional bicycle component. Optionally, the cover may include a hinge. Alternatively or additionally, the cover may not include a hinge. Optionally, the cover may hinder theft of a bicycle battery and/or components thereof. Optionally, the cover may cover a key hole of the native bolt (e.g., the bolt built into the battery rack) and/or lock between the bicycle battery and the rail. Optionally, the cover may include a hole through the cover and/or shield and/or rail facilitating access to a key hole and/or bolt between the bicycle battery and the shield and/or rail, for example to facilitate releasing the native bolt if it gets jammed.

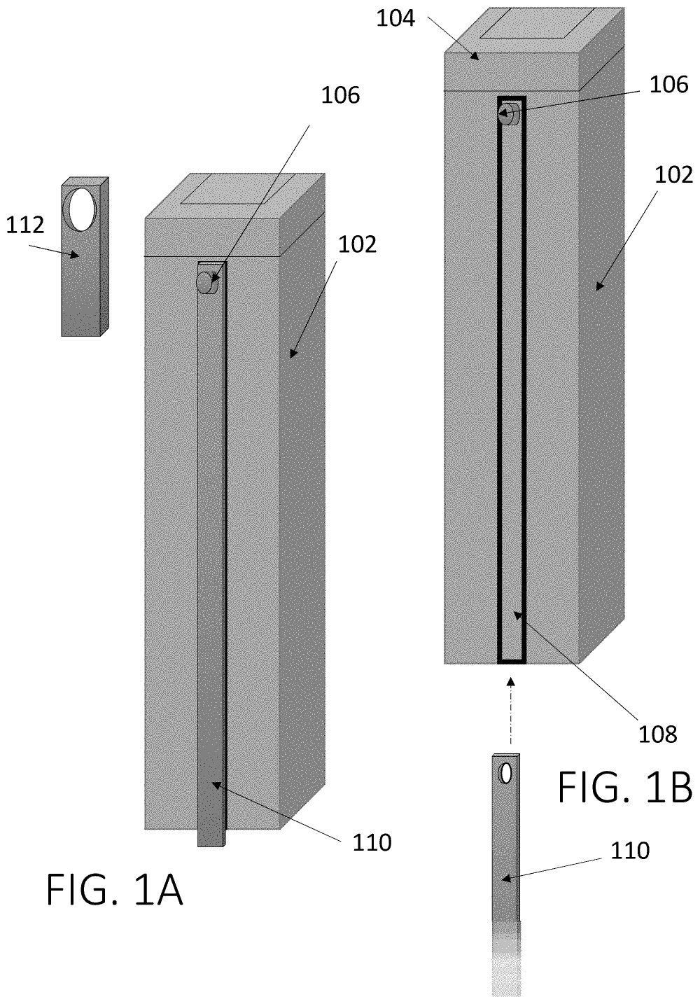

FIGS. 1A and 1B are schematic illustrations of a battery before and after attachment to a battery rail as found in some embodiments of the invention. For example, a bicycle battery 102 may include a handle 104 and a locking bolt 106 set within a groove 108 into which a battery rail 110 may be inserted. Optionally, a shield 112 may be attached to the upper portion of the battery rail 110.

According to some embodiments, an electric bicycle battery may be fitted to a bicycle with a rail. Optionally, the battery may be designed with one or more grooves. Optionally, a rail may be inserted to the groove, thereby holding the battery in place. Optionally, the groove may include one or more slits on one and/or both sides of the groove, e.g., such that when the rail is inserted to the groove, the battery body may partially and/or completely envelope the rail. Optionally, the battery may be raised and/or lowered and/or rotated and/or moved by a handle attached to the battery. Optionally, a battery may include a mechanism to secure the battery locked in position.

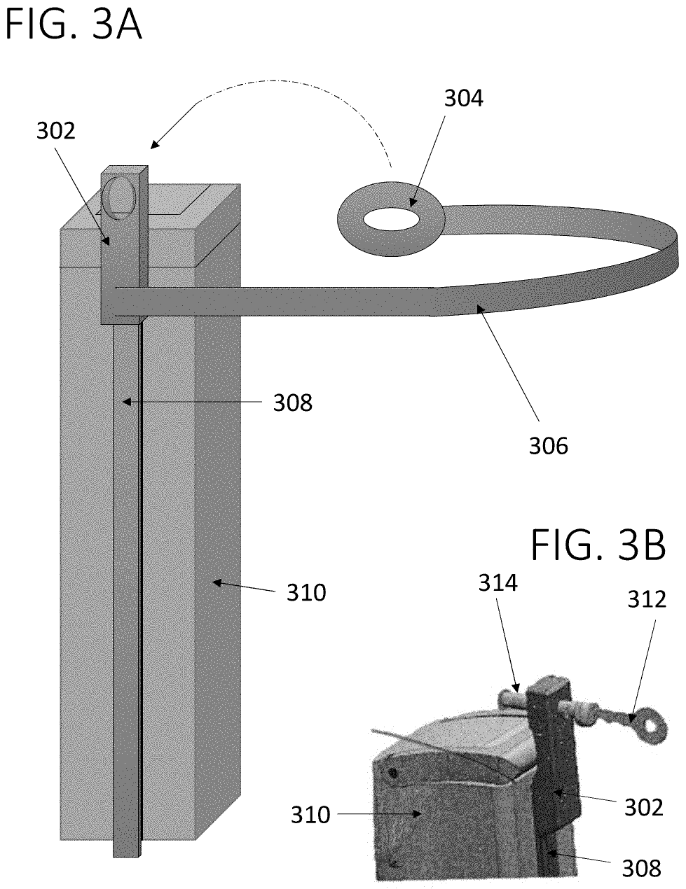

In some embodiments, a battery may include a locking bolt. Optionally, the bolt may be retracted into and/or extended from the battery, e.g., by rotation of a key. Optionally, the bolt may be positioned opposite a hole in the battery rail. Optionally, the rail may be fixed to an object such as the bicycle. Optionally, the bolt may be extended from the battery to pass through the hole in the rail, which may lock the battery in place on the rail (e.g., see FIG. 3B).

The theft of many bicycle batteries and/or parts thereof may occur due to tampering with the bolt. For example, a thief may hammer on the bolt which may cause it to go from an extended state to a retracted state. Once the bolt is in the retracted state the thief may then steal the battery and/or parts thereof from the bicycle. An additional method for tampering with and/or stealing a bicycle battery may be to insert a screwdriver and/or a bar into one of the sides and/or from above into one of the slits and/or pry it open. Once the slit is pried open the rail may be loosely connected to the battery and/or may be removed from the battery. Then the thief may steal the battery and/or parts thereof.

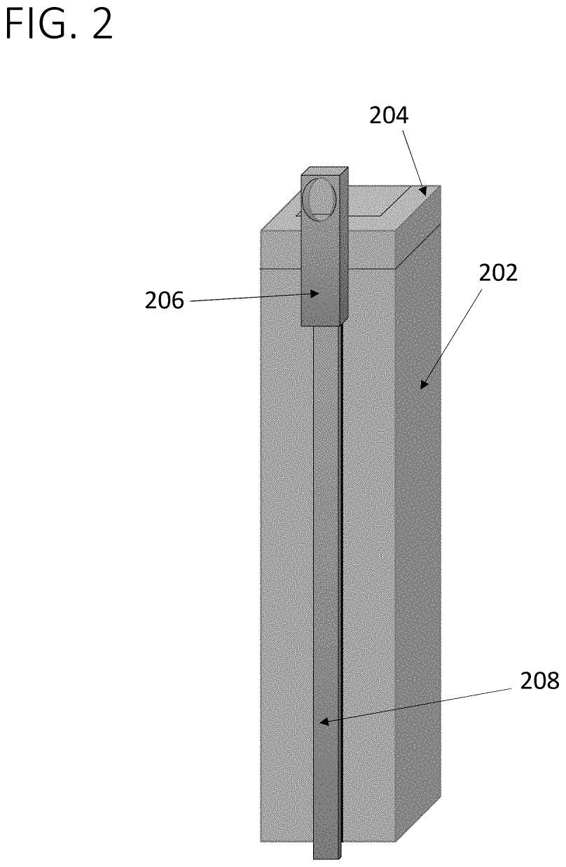

FIG. 2 is a schematic illustration of a battery attached to a battery rail with a shield in accordance with some embodiments of the invention. For example, a shield 206 may be attached to a battery rail 208 and/or to a battery 202. For example, the shield 206 may be attached close to the handle 204 of the battery 202.

In some embodiments, the system may inhibit theft of a bicycle battery. Alternatively, and/or additionally, in some embodiments, the system may include a shield and/or guard and/or cover that may hinder a thief, etc. from having access to the slits in the battery and/or the locking bolt of the battery and/or an upper portion of the battery.

In some embodiments, the shield may optionally be wider than the width of the rail. Optionally, the additional width of the shield and/or guard may cover the slits of the groove thereby hindering access to the slits with a bar and/or screwdriver. Optionally, the shield may be of various diffident lengths. Optionally the length and/or width of the shield may be adjustable. Optionally, the shield may extent above the upper portion of the rail and/or the upper portion of the battery. Optionally, the shield may cover only part of the rail. Optionally, the shield may cover the hole length of the rail. Optionally, the shield may not be connected to the rail. For example, a shield may cover between about 0.1 cm to about 3 cm, and/or between about 3 cm to about 10 cm, and/or between about 10 cm to about 50 cm of the length of the rail. Each possibility is a separate embodiment.

In some embodiments, the shield may cover the hole into which the locking bolt is extended. Optionally, covering the hole into which the locking bolt is extended may hinder the use of a hammer to forcibly retract the locking bolt. Optionally, the shield may have a hollow into which the bolt may extended. Optionally, this hollow only partially penetrates the shield, thereby protecting the bolt which may be inserted therein. Optionally, this may hinder a thief from accessing the bolt and/or from tampering with it.

Alternatively, and/or additionally, the hole in the shield may penetrate through the shield such that the end of the bolt may be accessed from the outside/back of the hollow. Optionally, the shield may be attached to the rail and/or to another part of the bicycle. Optionally, the shield may be attached to the battery. Optionally, the device may be made as a shield that may be attached to the upper portion of various standard battery rails. For example, it may be attached to the rail by screws that are covered by the battery when the device is connected and/or locked. Optionally, a shield may be made of metal (e.g., steel, iron, aluminum, chrome, etc.) and/or plastic (e.g., a hardened plastic, a thermoplastic, etc.) and/or other materials, and/or combinations thereof.

In some embodiments, the shield may extend laterally beyond the rail and/or one or more slits (e.g., groove in the battery) into which the rail may be inserted. Optionally, the lateral extension of the shield beyond the rail may block access to the rail and/or the one or more slits. For example, inhibiting a thief from inserting an instrument between the rail and/or the one or more slits and/or prying the rail away from the slit and/or away from the locking bolt. Optionally, the shield may extend laterally beyond the rail between about 0.5 mm to about 2.0 mm, and/or between about 2.0 mm to about 5.0 mm, and/or between about 5 mm to about 1 cm, and/or between about 1 cm to about 2 cm, and/or between about 2 cm to about 5 cm, and/or between about 5 to about 15 cm.

In some embodiments, the system may include an element that makes contact between the shield and the battery. For example, an element which may hinder the battery from moving. For example, an elastic element may be wedged between the shield and the battery which may hold the battery immobile. For example, an element which may hinder disconnection between the battery and the power connector of the bicycle when riding over bumps, etc.

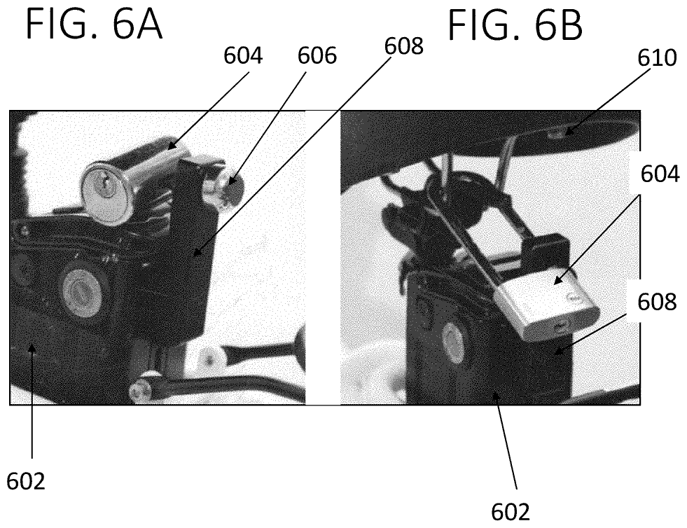

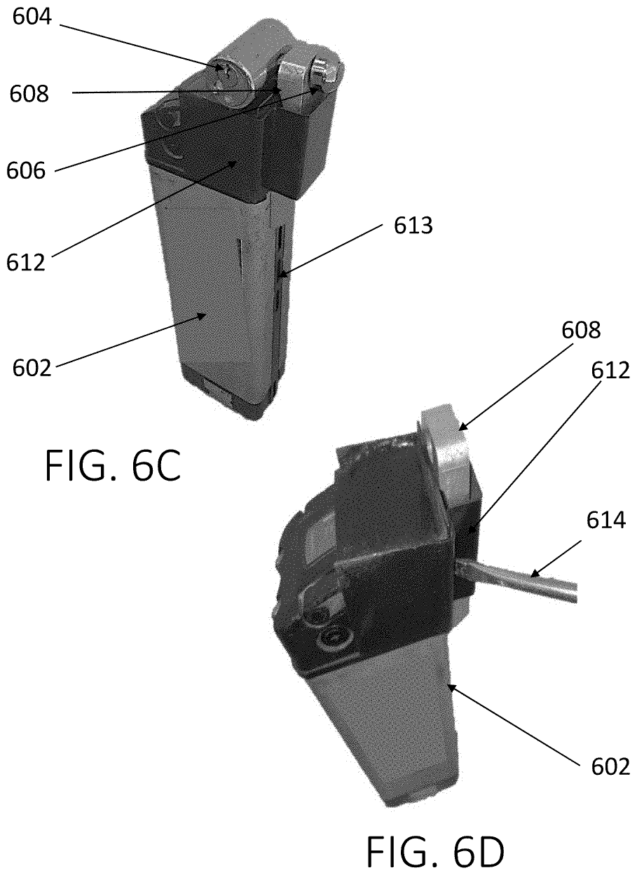

FIG. 3A is a schematic illustration of an exemplary battery attached to a battery rail with a shield and strap in accordance with some embodiments of the invention. For example, the battery rail 308 may be connected to a shield 302. Optionally, the shield 302 and/or rail 308 may be connected to a loop 306 e.g., including chain and/or strap and/or cable with an end connector 304. Optionally, the end connector 304 may be attachable to the shield 302. Optionally, a lock (e.g., lock 314 of FIG. 3B and/or lock 604 of FIGS. 6A and 6B inhibits removing end connector 304 from the shield 302 and opening loop 306.

Alternatively, and/or additionally, in some embodiments a shield may attach to another part of the bicycle and/or may attach to an external object. Optionally, this may hinder theft of the electric bicycle itself. In an embodiment, the shield may have a connector (for example, a chain and/or strap and/or cable and/or loop) connected to a shield and/or cover and/or rail e.g., the connector may be glued and/or bolted and/or welded and/or screwed onto a shield and/or cover and/or rail. For example, a shield may be connected to a strap and/or a chain and/or cable which may be connected to an additional object. Optionally, a connector may then be connected to another part of the bicycle and/or battery. Optionally, a connector may then be connected to one or more external objects. Optionally, this may hinder theft of the electric bicycle itself.

In some embodiments, the chain and/or strap and/or cable may be of metal and/or plastic and/or rubber and/or other materials and/or combinations thereof. Optionally, the chain and/or strap and/or connector may be of various lengths. Optionally, the chain and/or strap and/or cable and/or connector may be between about 0.1 cm to about 10 cm, and/or between about 10 cm to about 30 cm, and/or between about 30 cm to about 1 meter, and/or between about 1 meter to about 3 meters. Each possibility is a separate embodiment.

In some embodiments, the chain and/or strap and/or cable and/or connector may have an end connector at the distal end e.g., a loop, clip, lock, etc. Optionally, the end connector may be affixed over and/or to a part of the shield e.g., a part which may extend beyond the length of the battery. In some embodiments, the connection between the shield and the chain and/or strap may not be locked to the cover. For example, the connection between an end of the chain and/or strap may be hidden and/or shielded when the shield is in place. For example, this may hinder removal of the chain and/or strap unless one unlocks the shield and/or cover. Optionally, the end connector may be locked to the shield. Optionally, the chain and/or cable may be used as a bicycle chain, e.g., wrapping the chain around a sturdy object so that the bicycle may not be stolen.

In some embodiments, part of the shield may extend beyond the length of the battery. Optionally, the extension of the shield may include a hole. Optionally, an end connector may be pushed down onto the shield extension and/or over the hole. Optionally, an end connector may by pushed lower than the hole in the shield, facilitating locking in place, e.g., by a lock and/or bar which may be inserted into the hole and/or then locked, alternatively, the lock and/or bar may be fixed in the hole and/or slide further into and/or out of the shield when unlocked/locked. Optionally, the end connector may be locked to the shield. Optionally, the end connector may be hindered from being pull away from the shield.

Alternatively, and/or additionally, a connector may be connected to the shield and/or the rail at another location in the length of the battery. For example, at the bottom. Optionally, the connector may be detachable from the rail and/or shield. Optionally, the strap and/or chain and/or cable may be extendable.

FIG. 3B is a schematic illustration of an exemplary battery attached to a battery rail with a shield with lock in accordance with some embodiments of the invention. For example, a battery rail 308 may be affixed to a battery 310 and a shield 302. The shield may include a locking bolt 314 which may be extended and or retracted by rotation of a key 312.

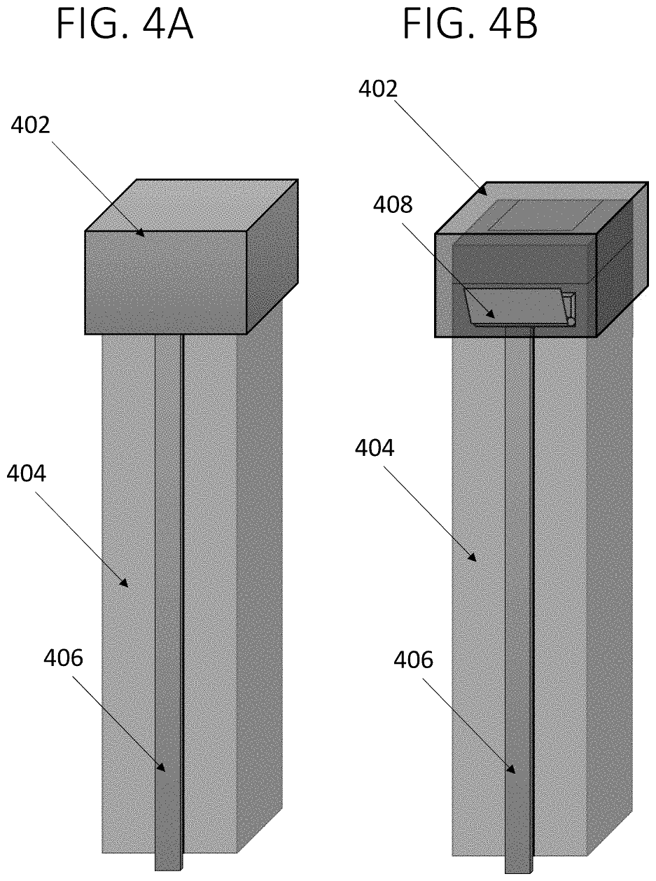

FIG. 4A is a schematic illustration of an exemplary battery attached to a battery rail with a cover in accordance with some embodiments of the invention, and FIG. 4B is a cut away view of a schematic illustration of an exemplary battery attached to a battery rail with a cover in accordance with some embodiments of the invention. For example, A battery 404 may be attached to a rail 406 and an upper portion of the battery 404 and/or the rail 406 may be covered with a cover 402. Optionally, the cover 402 may be attached to the rail 406. Optionally, the cover 402 may be attached to the rail 406 with a hinge 408, which may facilitate opening and/or closing of the cover over the upper portion of the battery 404.

Alternatively, and/or additionally, in some embodiments, the system may include a cover, which may be locked to various parts of the bicycle. Optionally, the cover may cover the battery upper portion from all and/or one or more sides. Optionally, the cover may be hinged, for example, to be opened and/or closed. Optionally, the cover may include a locking system to lock it in a closed position. Optionally, one or more sides of the cover may be locked to one or more parts of the bicycle. Optionally, the cover may be attached to a part of the bicycle by gluing and/or welding and/or screws and/or it may detachable. Optionally, a secure cover may hinder a thief s from lifting the battery from its place.

In some embodiments, a cover may cover a key hole which may be on the battery. Optionally, a key hole may extend into the locking bolt. Optionally, an extension may cover the key hole. Optionally, this may hinder theft and/or tampering with the key hole. Alternatively, and/or additionally, the cover may hinder moving the handle of the battery and/or cover the screws at the upper portion of the battery, e.g., to hinder a thief from accessing the electronics inside the battery. Optionally, the cover may only protect the battery from one or more sides and/or may fully cover, partially cover or not cover the upper portion of the battery. Optionally, the cover may be designed to cover the battery and/or to cover and/or attach to additional parts (e.g., the seat of the bicycle). Optionally, the cover may protect the upper portion of the battery from other damage e.g., from rain and/or sunlight.

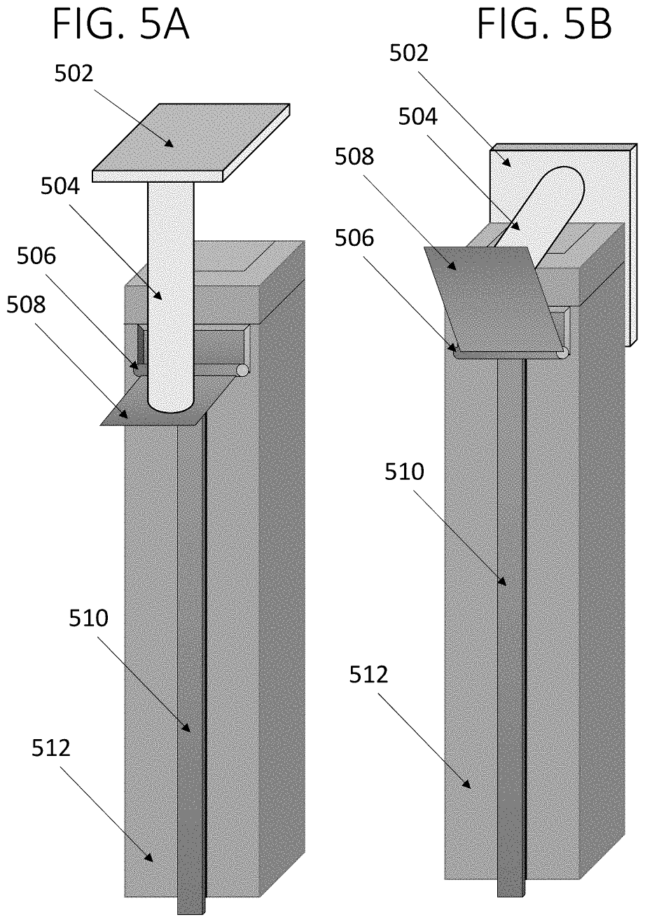

FIGS. 5A and 5B are schematic illustrations of an exemplary battery attached to a battery rail with an open cover, and closed cover, respectively, in accordance with some embodiments of the invention. For example, a battery 512 may be connected to a battery rail 510 on which a shield 508 may be mounted. The shield may be hinged 506. The shield 508 may be attached to a bar or handle 504 which may in turn be connected to a cover 502.

In some embodiments, a cover and/or shield may include one or more hinges which may be attached to a part of the bicycle (e.g., the battery rail). Optionally, the cover may be locked into a closed position over and/or around an upper portion of the battery. Optionally, a shield on the proximal end may be attached to a handle and/or bar which may be connected to a cover on the distal end. Optionally, the bar may secure the battery in place when closed. Optionally, a cover may cover the upper portion and/or one or more sides of the battery when secured closed. Optionally, this may hinder tampering such as theft of the battery and/or parts from within the battery. Optionally, a panel may be screwed on one or more sides of the battery to cover the electronic parts of the battery. Optionally, the battery may be held in place from another angle e.g., by holding screws. Optionally, the cover may cover these screws and/or other vulnerable places. Optionally, the cover on the distal end of the bar may be adjustable in size and/or shape. Optionally, the bar may act as a handlebar for a user sitting behind the rider. For example, the bar may be used as a handlebar for a child sitting in a child seat. Optionally, the cover may be designed with a handle that a child sitting in a rear child seat may hold onto e.g., when the cover is in the open and/or closed position.

In some embodiments, a cover may assist in holding the battery securely in place during riding. Optionally, the cover may push against the upper portion of the battery and/or include a clamp which may push against the side of the battery (e.g., with an elastic and/or flexible part). Optionally, this may hinder the battery from bouncing and/or disconnected from the electrical connector of the bicycle, for example when the bicycle bounces over an obstacle. Optionally, a clamp may be held tight with a quick release handle.

FIGS. 6A-D are exemplary images illustrating a method in accordance with an embodiment of the current product. For example, a shield 608 may be connected to a battery rail (not shown) that fits into a groove 613 in a bicycle battery 602. Optionally, the shield 608 may include a hole through which a locking bolt 606 or lock 604 may pass. Optionally, the lock 606 may also connect the shield 608 to one or more additional parts of the bicycle, e.g., the saddle 610. For example, the shield may have a hole through which the hasp of a lock may be passed. Optionally, a cover 612 may fit over the upper portion of the battery 602 and the shield 608. Optionally, the cover 612 may be locked in place by the locking bolt 606 and/or a lock 604. Optionally, the cover 612 may hinder tampering e.g., by hindering access to the battery 602 with a screwdriver 614 and/or another tool.

In some embodiments, a shield may include an extension which may extend above the upper portion of the rail. Optionally, the extension may include a hole in it. Optionally, a user may run a lock through the hole and lock it. Optionally, this may lock the battery in place hindering theft of the battery and/or parts thereof. Optionally, a user may extend a long lock that may attach to one or more additional components of the bicycle, e.g., saddle, peddles, gear chain, handlebar, child seat, luggage rack, etc. Optionally, may also hinder the battery and/or one or more additional components of the bicycle from being stolen. Optionally, a lock may be built into the shield and/or the cover and/or the rail. Optionally, a lock may be designed to connect to various parts of the bicycle.

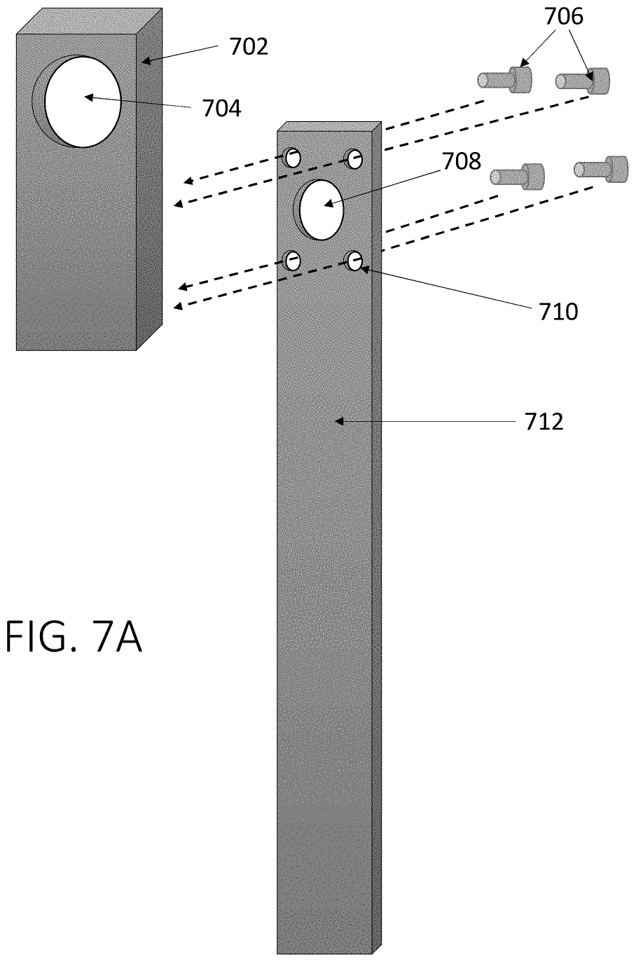

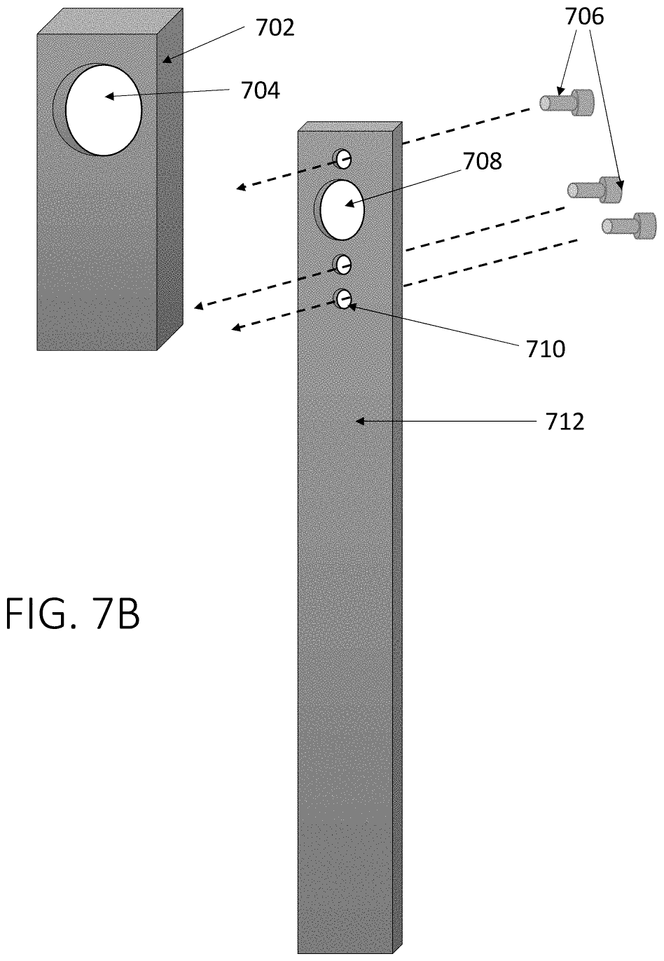

FIGS. 7A and 7B are schematic diagrams illustrating an exemplary method in accordance with some embodiments of the invention. For example, a rail 712 may include one or more screw holes 710 and/or a locking bolt hole 708. The screws 706 may pass through the screw holes 710 into corresponding screw holes and/or anchors (not shown) on a shield 702. Optionally, the shield 702 may include a locking bolt hole 704.

In some embodiments, the rail may include one or more holes. Optionally, the holes may be part of the original design of the rail. Optionally, the holes may be drilled into the rail after manufacture. Optionally, holes may be drilled into the rail in order connect a shield. Optionally, various configurations of holes may be drilled in a rail due to its size and/or shape and/or length. Optionally, one or more screws may connect the rail through the holes to a shield. Optionally, the shield may include one or more corresponding screw holes. Optionally, the shield may include one or more anchors to accommodate the one or more screws. Optionally, a shield may be configured to accommodate various configurations of holes drilled in a rail. Optionally, this could be a method for attaching the shield to the rail. Optionally, screws may be inserted through the holes from the backside (i.e., from the side of the battery) and/or inserted into screw holes in the shield. Optionally, this may hinder access to the screws when then battery is in place. Optionally, the screws may be connected to the shield from the inside, thereby hindering thieves from removing the shield.

Alternatively, and/or additionally, the screws may be connected from the outside such that when the battery is locked to the rail, the battery covers the screws and/or hinders a thief from tampering with them. Optionally, the screws connecting the shield to the rail may pass through a central portion of the rail (e.g., not the sides). Optionally, a protrusion (e.g., a screw) in the shield above the locking bolt of the battery may inhibit a thief from inserting a screw driver from above the rail between the rail and the battery and releasing the battery from the rail. Optionally, a protrusion (e.g., a screw) in the shield above the locking bolt of the battery may block upward movement of the battery such that even if a thief succeeds in disconnecting the locking bolt from the shield, the protrusion (e.g., the screw) protruding backwards from the rail may hinder the battery from being pulled out of the bicycle.

Alternatively, and/or additionally, the shield may be attached to the rail by welding, gluing, bolting, clipping, screwing, etc., and/or any combination thereof. Note that in some embodiments the attachment between the shield and the rail may be reversible (for example by means of screw or bolts and/or without welding). Optionally, when locking the shield to inhibit removal of the battery also inhibits access to the attachment of the rail to the shield and/or inhibits separating the rail from the shield.

Alternatively, and/or additionally, the system may be configured to tighten the battery to the rail. Optionally, may reduce movement of the battery while riding (e.g., bouncing), which may cause the battery to disconnect from the connector and/or loss or reduction of power. Optionally, a tightener, such as a wheel quick release, may clamp the battery to the rail. Optionally, the cover and/or bar may be tight enough to hold down the battery.

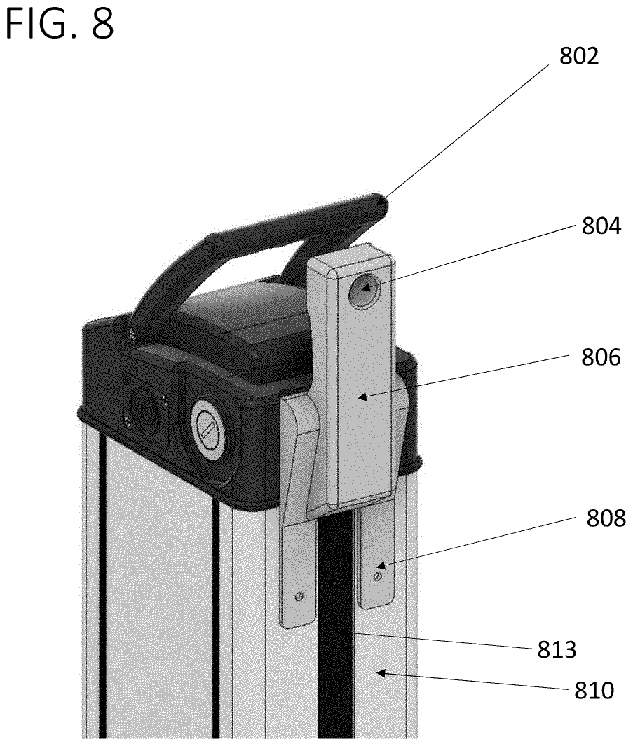

FIG. 8 is a schematic diagram illustrating an exemplary battery connected to a shield in accordance with some embodiments of the invention. For example, a shield 806 may include a locking bolt hole 804. Optionally, the shield may include sideways and/or downward extending extensions 808. For example, extensions 808 may extend around an upper portion of a groove 813 of the battery 810. For example, the extensions 812 may inhibit insertion of a screw driver into groove 813 to pry a rail away from the battery 810. Alternatively or additionally, extensions 812 may be attached directly to the battery 810 by one or more connectors 808 and/or be separate from shield 806. For examples, extensions 812 may inhibit insertion of a screwdriver behind shield 806 to pry it away from the battery. Optionally, the shield 806 may be connected to the upper portion of the battery in a manner which may not obstruct the handle 802. Optionally, the shield 806 may be attached to the battery 810 by welding, gluing, bolting, clipping, screwing, etc., and/or any combination thereof.

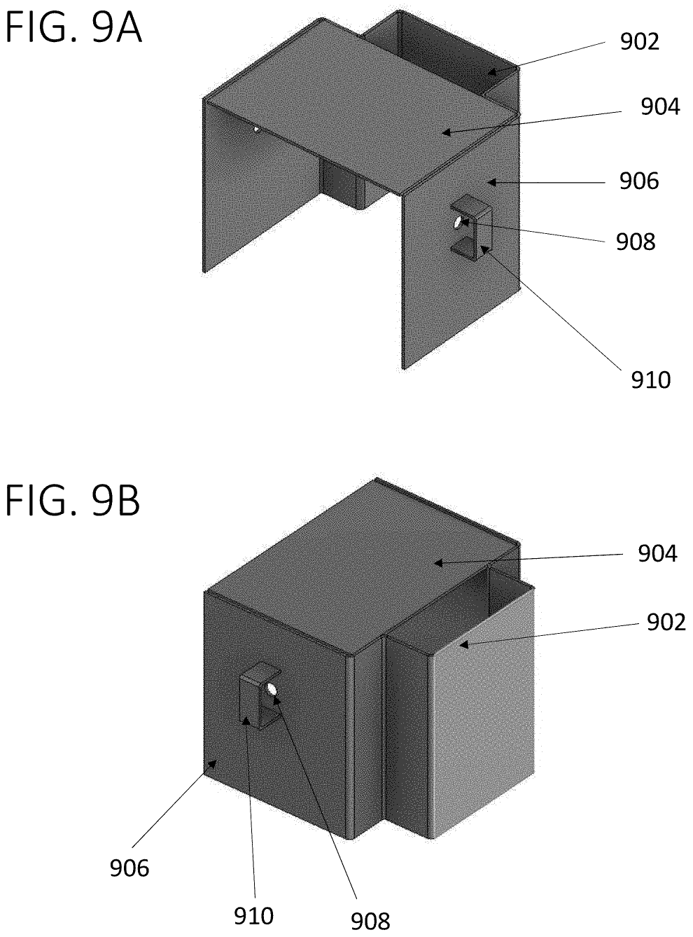

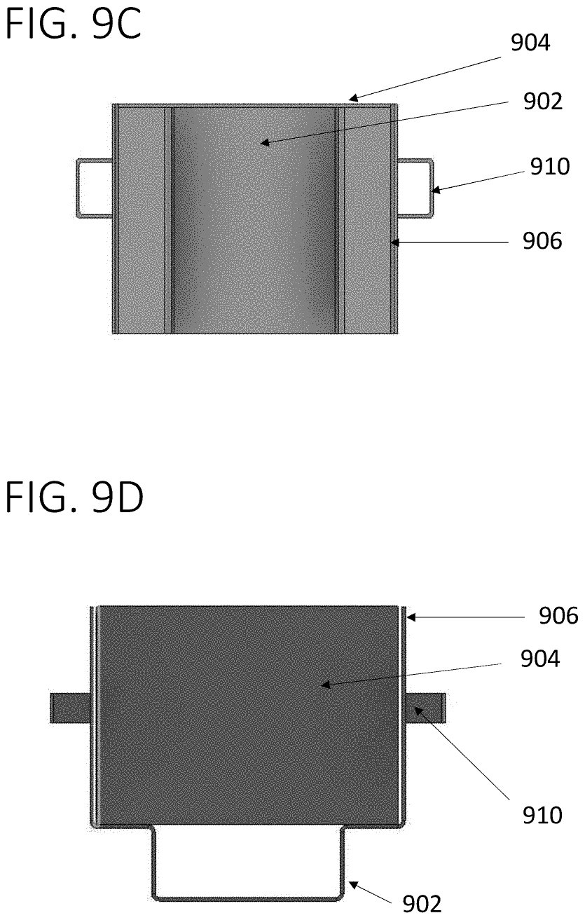

FIGS. 9A-D are various views of schematic diagrams illustrating an exemplary cover in accordance with some embodiments of the invention. For example, the cover may include a pocket and/or extension 902 to accommodate a rail and/or shield (not shown) on its proximal side. Optionally, the cover may include an upper cover 904 and/or one or more sides 906. Optionally, one or more sides 906 may include one or more cable housing elements 910 and/or one or more holes 908 through which a lock, chain, strap, cable, etc. (not shown) may be threaded. Optionally, the cover may be made of metal (e.g., steel, iron, aluminum, chrome, etc.) and/or plastic (e.g., a hardened plastic, a thermoplastic, etc.) and/or other materials and/or combinations thereof. Optionally, the cover may hinder access to the battery and/or parts thereof. Optionally, the cover may hinder attempts to steal the battery and/or parts thereof.

In some embodiments, a cover will include a sleeve that surrounds the shield and/or the rail where they are connected. For example, a cover may include and/or consist of a sleeve surrounded the rail and/or shield where they are connected. A lock may hold the cover in place such that removal of the shield from the rail is inhibited when the cover and lock are engaged.

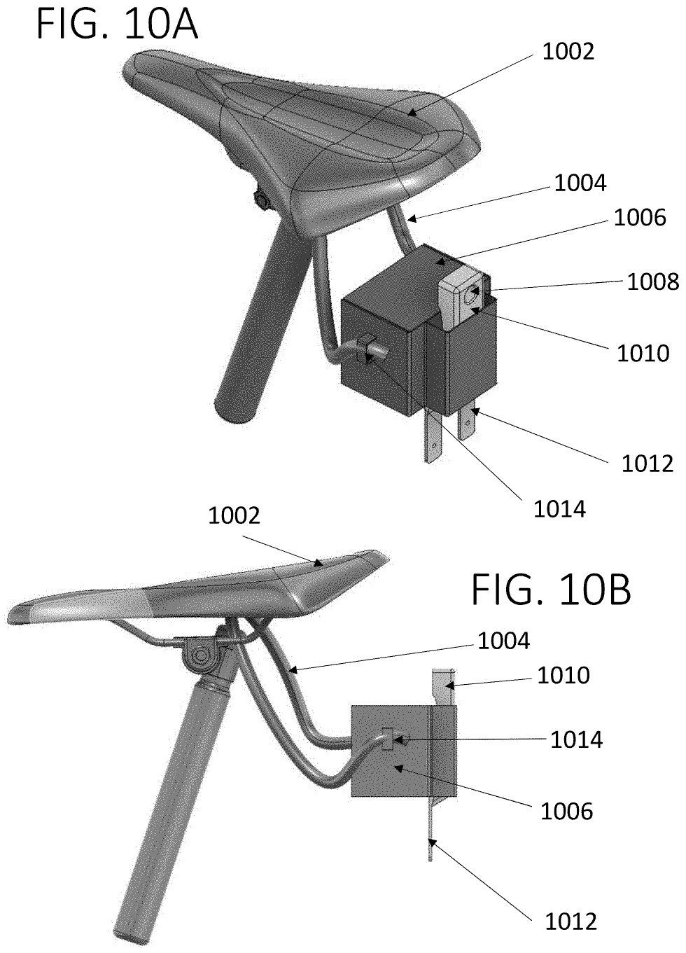

FIGS. 10A and 10B are schematic illustrations of an exemplary anti-theft system in accordance with some embodiments of the invention. For example, the cover 1006 may fit over a shield 1010 including a locking bolt hole 1008 and one or more connectors 1012 for connection to a battery and/or rail. Optionally, the cover 1006 may be connected to another part of the bicycle, e.g., a saddle 1002, by one or more loops 1004, for example made of chains, straps, wires, cables, etc. which may be inserted through an interference element 1014 on one or more sides of the cover 1006 and/or threaded through one or more holes in the one or more sides of the cover. Optionally, this may hinder access to the ends of the one or more loops and/or to a connector connecting the end of the loop to the cover and/or connecting together the ends of the loop. Thus, the lock Figs holding the cover to the battery may inhibit removing the loop from the saddle. For example, when the cover is connected to a battery and/or held onto a battery, access to the connection between the strap and the cover may be blocked making it difficult to separate the strap from the cover without removing the cover. The cover may be held to the battery by a lock and/or the rail and/or the shield.

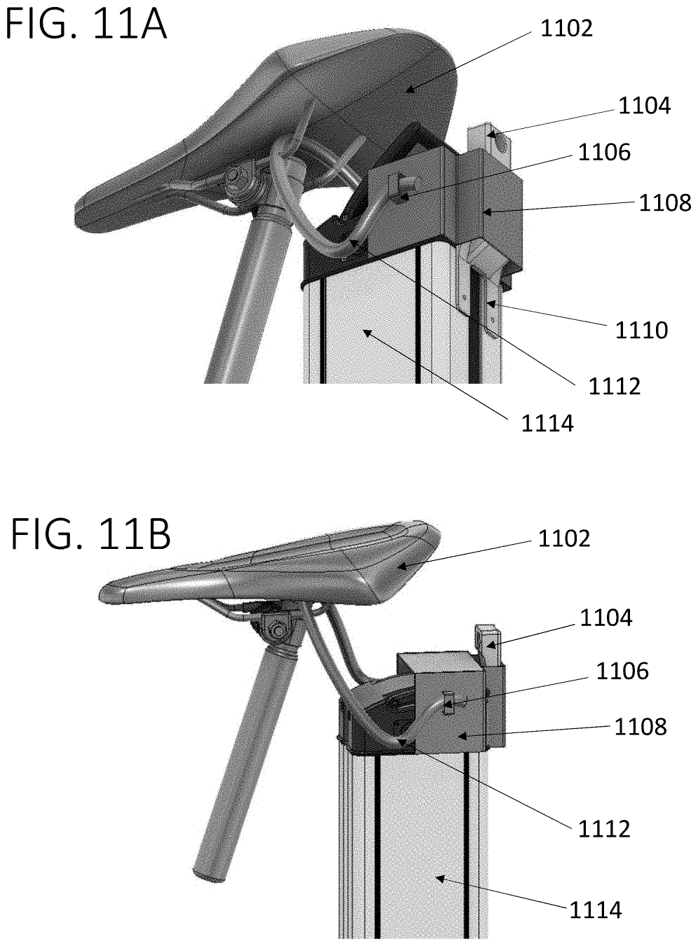

FIGS. 11A and 11B are schematic illustrations of an exemplary anti-theft system in accordance with some embodiments of the invention. For example, the cover 1108 may fit over a shield 1104 including a locking bolt hole and one or more connectors 1110 for connection to a battery 1114 and/or rail (not shown). Optionally, the cover 1108 may be connected to another part of the bicycle, e.g., a saddle 1102, by one or more cables, chains, straps, wires, etc. 1112 which may be inserted through an interference element 1106 on one or more sides of the cover 1108 and/or threaded through one or more holes in the one or more sides of the cover. Optionally, this may hinder access to the ends of the one or more cables, chains, straps, wires, etc. 1112 and/or to a lock connected thereto.

In some embodiments, the cover may make inhibit separating the shield from the battery. For example, if a thief tries to force the shield backwards and/or sidewards and/or downwards (for example hitting the shield and/or the cover with a hammer) the force will be transferred to the cover and/or the battery. Thus rather than separating or along with separating the shield from the battery, the battery itself may be damaged. Along with preventing removal of the battery, damaging the battery may reduce its value and the danger of damaging the battery may reduce motivation of a thief.

In some embodiments, their may be a way to adjust the length of a cable 1112. For example, cable 1112 may be attached to a cover (e.g., cover 904) by a bolt pushing through a hole 908 and/or sandwiching the cable against a cable housing element 910. For example, the cable may be slide in the housing element 910 to tighten it against the saddle 1002 and/or the bolt tightened to immobilize the cable 1112. When the cover 904 is locked to the battery the bolt may covered inhibit releasing the cable. Optionally the tight cable may inhibit pushing backwards the cover 904 and/or the shield 1010.

One possible advantage of the cable holding the cover to the bicycle is that the cover remains attached to the bicycle when the battery is removed. Optionally, other connections (e.g., a hinge and/or a sliding connection) may be used to release the battery while the cover remains connected to the bicycle.

In some embodiments, a cable, chain, strap, wire, etc. may connect the cover to a bicycle saddle. Optionally, this may hinder theft of the saddle. Optionally, a cable, chain, strap, wire, etc. may hold the cover and/or shield and/or rail in place. Optionally, a cable, chain, strap, wire, etc. may inhibiting pulling the rail away from the battery. Optionally, the cable, chain, strap, wire, etc. may use a separate lock. Optionally, the cable, chain, strap, wire, etc. may not use a separate lock. Optionally, the attachment between the cable, chain, strap, wire, etc. and the cover may only be released when the cover is not positioned over the battery. Optionally, a bolt and/or lock may attach the cable, chain, strap, wire, etc. to the cover. Optionally, the bolt may be located inside the cover. Optionally, the bolt may only be accessed and/or released when the cover is removed from the battery. Optionally, the lock of the shield may hold the cover to the battery hindering access by a thief.

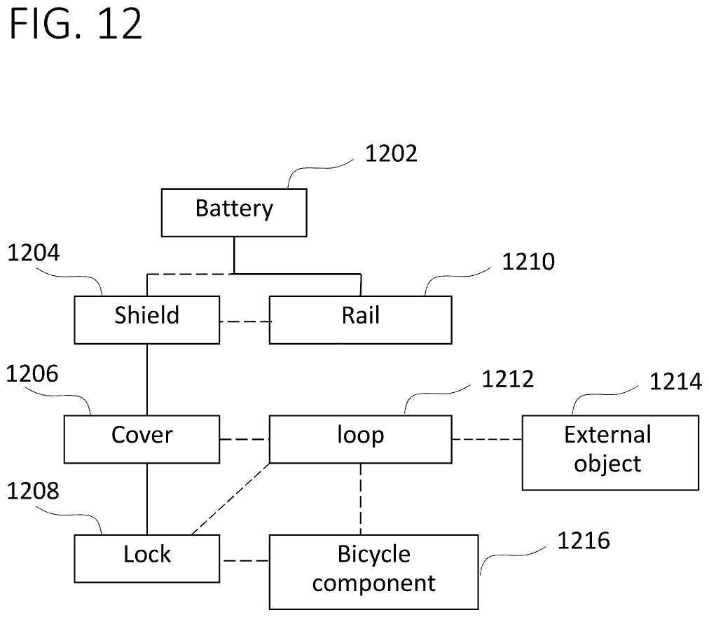

FIG. 12 is a block diagram illustrating an exemplary anti-theft system in accordance with some embodiments of the invention. For example, a battery 1202 may be attached to a rail 1210 and/or a shield 1204. Optionally, the shield 1204 may be attached to the rail 1210. Optionally, the shield 1204 may be attached to the battery 1202. Optionally, a shield 1204 may be connected to a cover 1206 which may be locked in place, e.g., by a lock 1208. Optionally, the cover 1206 may be connected to an additional bicycle component 1216 by a chain 1212 and/or a lock 1208. Optionally, the additional bicycle component 1216 may be a saddle, peddles, gear chain, handlebar, child seat, luggage rack, etc. Optionally, this may hinder theft of an additional bicycle component. Optionally, the chain 1212 may be connected to the lock 1208. Optionally, the cover 1206 may be connected to an external object 1214 by a loop 1212 (e.g., a chain and/or cable) and/or lock 1208. Optionally, the external object may be a sturdy object such as a pole, flower pot, bicycle rack, lamp post, building, tree, etc. Optionally, this may hinder theft of the electric bicycle itself. The the lock 1208 may inhibit opening the loop 1212. For example, one end the loop 1212 may be connected to the bicycle, the cover 1206, the battery, the other end of the loop 1212 and/or the shield 1204 in a location that is covered by the cover 1206 and/or the lock 1208 may inhibit removing an end of the loop 1212 from the shield 1204 (e.g., one end of the loop 1212 may include a small loop looped around the shield 1204 that is hindered from passing over an end of the shield 1204 by the lock 1208.

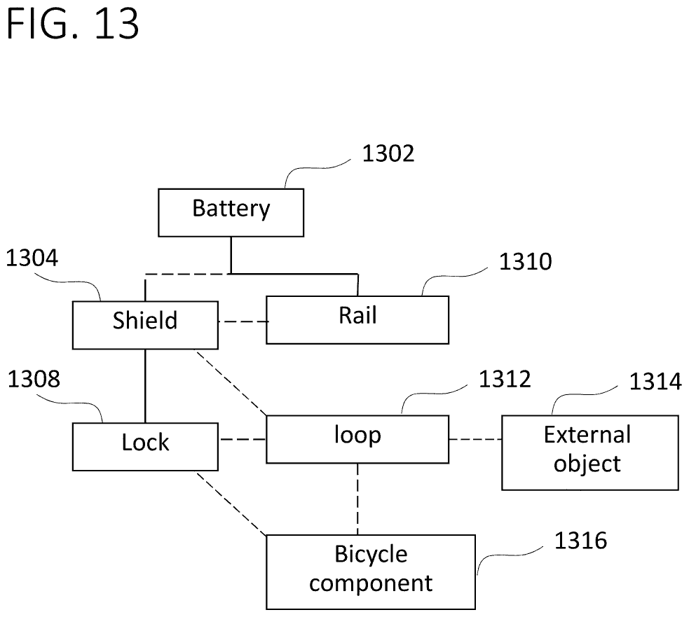

FIG. 13 is a block diagram illustrating an exemplary anti-theft system in accordance with some embodiments of the invention. For example, a battery 1302 may be attached to a rail 1310 and/or a shield 1304. Optionally, the shield 1304 may be attached to the rail 1310. Optionally, the shield 1304 may be attached to the battery 1302. Optionally, a shield 1304 may be locked in place, e.g., by a lock 1308. Optionally, the shield 1304 and/or the lock 1308 may be connected to an additional bicycle component 1316 by a loop 1312. Optionally, the additional bicycle component 1316 may be a saddle, peddles, gear chain, handlebar, child seat, luggage rack, etc. Optionally, lock 1308 may hinder removal of the loop 1312. Optionally, this may hinder theft of an additional bicycle component. Optionally, the shield 1304 and/or lock 1308 may be connected to an external object 1314 by a chain 1312. Optionally, the external object may be a sturdy object such as a pole, flower pot, bicycle rack, lamp post, building, tree, etc. Optionally, this may hinder theft of the electric bicycle itself.

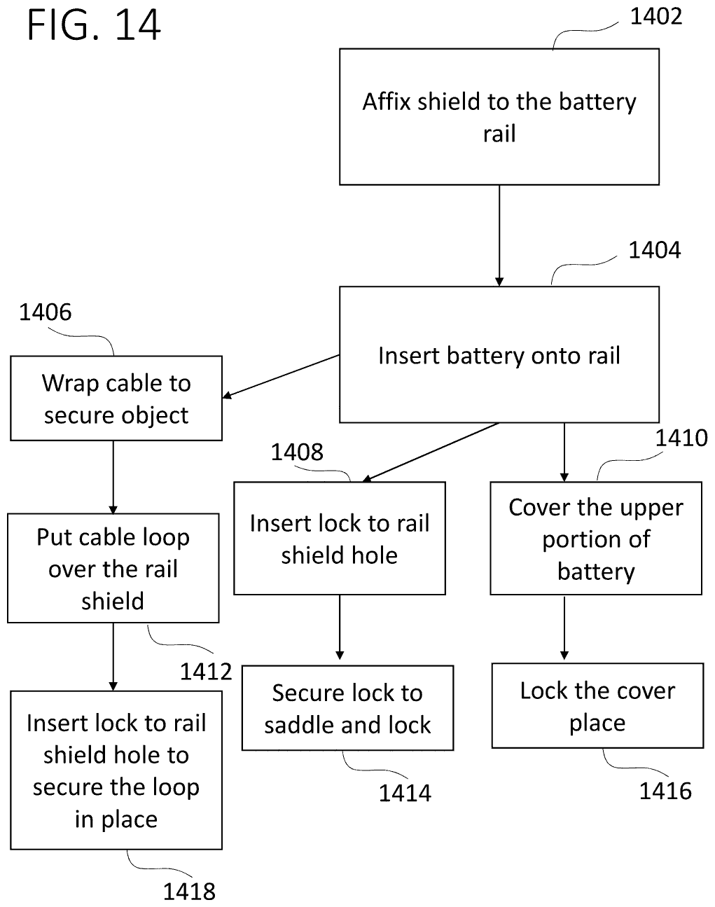

FIG. 14 is a flow chart illustrating exemplary methods of use of an anti-theft system in accordance with some embodiments of the invention. For example, affixing 1402 a shield to a battery and/or battery rail, and/or inserting 1404 the battery onto the rail. According to some embodiments, locking 1408 a lock through a hole on the shield and/or rail. Optionally, securing 1414 an additional bicycle component (e.g., a saddle) to the lock. Additionally, and/or alternatively, wrapping 1406 a cable to secure an object (e.g., a bicycle component such as a battery, saddle, etc. and/or an external object such as a lamp post, bicycle rack, tree, etc.), putting 1412 a cable end loop over the rail shield, and inserting 1418 a lock through the rail shield hole to secure the loop in place. Additionally, and/or alternatively, covering 1410 the upper portion of the battery with a cover. Optionally, the cover may be attached to the rail and/or shield and or battery. Optionally, the cover may be attached to the rail and/or shield and or battery by a hinge which may be rotated over the upper portion of the battery. Optionally, locking 1416 the cover in place.

In some embodiments, a user may affix a shield to a battery rail. Optionally, a user may bolt the shield to the rail. Optionally, a user may wrap a cable that is attached to the shield to a sturdy object, such as a tree. Optionally, a user may put the cable end loop over the top of the shield. Optionally, a user may insert a lock to secure the loop in place on the shield.

Alternatively, and/or additionally a user may insert a lock into a hole in the shield. Optionally, a user may lock the shield to the saddle. Optionally, the lock may hinder the battery from being removed and/or being removeable while locked in place. Alternatively, and/or additionally, a user may cover the upper portion of a battery and/or a shield with a cover. Optionally, the cover may include a hinge. Optionally, the cover may not include a hinge. Optionally, the cover may be locked in place. Optionally, the cover may block the battery from being removed and/or being removeable while locked in place.

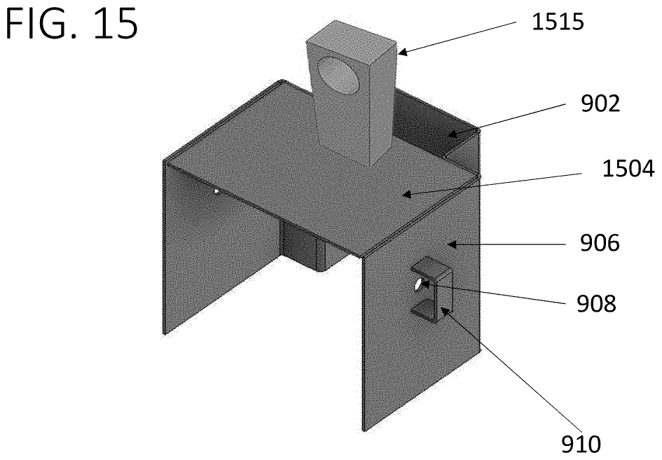

FIG. 15 is a perspective view of a cover with a hasp 1515 in accordance with an embodiment of the current invention. In some embodiments, a cover will include a hasp 1515 that facilitates locking the cover 1504 to the shield (e.g., shield 1104). For example, a cover may slide forward to release the battery and/or slide backwards and lock to the shield. Optionally, a cover on a hinge may rotate down and slide over the battery and then be locked using a hasp 1515. A possible advantage of such an embodiment is that the cover remains connected to the bicycle when the battery has been removed.

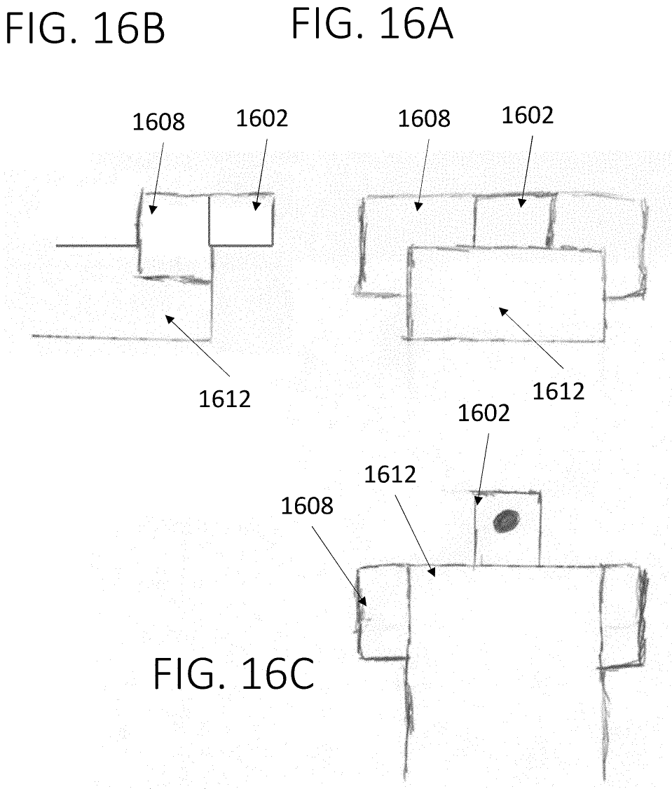

FIG. 16A is a top orthogonal view of a shield 1602 with sideways extensions 1608 in accordance with an embodiment of the current invention. In some embodiments, a shield 1602 may include side extensions 1608. For example, extensions may extend over some or part of the rear of the battery 1612 (e.g., on the sides of the groove of the rail) and/or the sides of the battery 1212. For example, the shield may prevent moving the shield 1204 sideward and/or inserting a screwdriver between the back of the battery 1212 and the shield 1204. Alternatively or additional, the extensions may over part of the front of the battery. For example, the shield 1602 may include a ring that wraps around the battery on four sides inhibiting separation of the shield from the battery forward, backward and/or sidewards.

FIG. 16B is a side orthogonal view of a shield with sideways extensions in accordance with an embodiment of the current invention.

FIG. 16C is a front orthogonal view of a shield with sideways extensions in accordance with an embodiment of the current invention.

### GENERAL

It is expected that during the life of a patent maturing from this application many relevant building technologies, artificial intelligence methodologies, computer user interfaces, image capture devices will be developed and the scope of the terms for design elements, analysis routines, user devices is intended to include all such new technologies a priori.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A system preventing theft system of a battery of an electric bicycle comprising:
a rail connecting the battery to the electric bicycle;
a shield attached to an upper portion of the rail; and
a lock, connecting to the shield and inhibiting removal of the battery from the electric bicycle.

2. The system of claim 1, wherein an attachment between the rail and the shield is covered by the battery when the lock in connected to the shield to inhibits removal of the battery thereby inhibiting separating the shield from the rail.

3. The system of claim 1, further comprising a cover at least partially covering said shield and inhibiting access to a location of attachment of the shield and the rail.

4. The system of claim 3, wherein said lock inhibits removing said cover from said shield.

5. The system of claim 1, further comprising a cover held to an upper portion of the battery by said lock.

6. The system of claim 5, wherein the cover surrounds the upper portion of the battery, including a portion of four sides thereof.

7. The system of claim 5, wherein the cover is attached to the shield or the rail by a hinge.

8. The system of claim 5, wherein the cover is connected to an additional bicycle component.

9. The system of claim 8, wherein the cover is connected to an additional bicycle component by at least one loop of a cable, a strap or a chain.

10. The system of claim 9, wherein the lock prevents disconnection of the loop from at least one of the covers and the shield.

11. The system of claim 8, wherein the cover covers a key hole of a native bolt between the electric bicycle battery and the rail.

12. The system of claim 1, wherein the lock and the shield are connected to an additional bicycle component.

13. The system of claim 12, wherein the lock and the shield are connected to an additional bicycle component by a loop.

14. The system of claim 12, wherein a connection between the shield and the additional bicycle component is tight enough to inhibit moving the shield away from the battery.

15. A method of preventing theft of a battery of an electric bicycle comprising:
connecting the battery to the electric bicycle battery by a rail
affixing a shield to at least one of the battery and the rail; and
locking a lock to the shield inhibiting removal of the battery from the rail.

16. The method of claim 15, further comprising covering an upper portion of the battery with a cover, wherein the cover is positioned below the lock such that the lock inhibits removal of the cover from the battery.

17. The method of claim 16, further comprising rotating the cover around a hinge to cover the upper portion of the battery.

18. The method of claim 15, further comprising covering a connection between the rail and the shield with a cover, wherein the cover is positioned below the lock such that the lock inhibits removal of the cover from the battery.

19. The method of claim 16, further comprising securing an additional bicycle component to the lock, shield, cover, or combination thereof.

20. The method of claim 19, wherein said securing is by means of a loop and further comprising connecting an end of the loop to the shield, and inhibiting removal of the loop from the shield by means of the lock.
